(19) United States
(12) Patent Application Publication
(10) Pub. No.: US 2008/0105311 A1
(43) Pub. Date: May 8, 2008

(54) Distributor for Liquids

(75) Inventor: Christoph Bulter, Horstel-Bevergern (DE)

Correspondence Address: GUDRUN E. HUCKETT DRAUDT, SCHUBERTSTR. 15A, WUPPERTAL, 42289, omitted

(73) Assignee: OASE GmbH, Horstel-Riesenbeck (DE)

(21) Appl. No.: 11/306,426

(22) Filed: Dec. 28, 2005

(30) Foreign Application Priority Data
Jan. 6, 2005 (DE) 202005000143.0

(51) Int. Cl. F16K 11/10; B65D 69/00

(52) U.S. Cl. 137/625.11; 206/223

(57) ABSTRACT

A distributor for liquids has a base member having an intake and at least two outlets. At least one branch member is connected to one of the at least two outlets in a position that is changeable relative to the base member. The at least one branch member has an outlet opening. A distributor kit has a distributor, a closure element for closing one of the at least two outlets of the base member of the distributor, and branch elements for each one the outlets that is not closed off by the closure element.

### BACKGROUND OF THE INVENTION

The invention relates to a distributor for liquids having an inlet opening and at least two outlet openings.

Such distributors for liquids are known, for example, in connection with watering systems for gardens, in the form of T-members or cross-members as connecting and branching elements between hoses or pipes. Water that flows in through the inlet opening of the distributor for liquids is distributed to two or three outlet openings that are positioned in the same plane as the inlet opening. There is great interest that the watering system and, in particular, the integrated distributors for liquids can be matched to the respective requirements in different gardens.

### SUMMARY OF THE INVENTION

It is an object of the present invention to provide a distributor for liquids of the aforementioned kind that is characterized by great adaptability.

In accordance with the present invention, this is achieved in that the distributor comprises a base member comprising one intake and at least a first outlet and a second outlet, wherein at least one of the outlets is connected to a branch member that is adjustably positionable relative to the base member, and in that the branch member provides one of the outlet openings of the distributor.

In accordance with the present invention, this is achieved moreover in that a kit is provided that comprises a distributor for liquids as described above, a closure element for closing one of the outlets, and branch members for each one of the remaining outlets of the base member.

The distributor for liquids has a base member with one inlet and at least a first outlet and a second outlet. At least one of the outlets is connected to a branch member. By providing the branch member with one of the outlet openings and by enabling the branch member to change its position relative to the base member or to the inlet and the outlets of the base member, the adaptability of the distributor for liquids is significantly improved.

In a preferred configuration of the present invention the branch member is detachably connected to the base member. The position of the branch member to the base member can thus be changed by removing the branch member from the base member. The outlet that is released upon removing the branch member can be connected to a branch member that is different from the one that has been removed. This different branch member can differ from the first branch member, for example, by having an outlet opening with a different diameter. Especially preferred diameters of the outlet opening are one inch, three-quarter inch, and one half inch. Instead of being connected to another branch member, the released outlet can expediently be closed by a closure element, preferably in such a way that it is substantially water-tight.

The distributor for liquids is thus adaptable to different requirements or conditions in individually designed gardens. Any number of outlets of the base member of the distributor for liquids can be either closed by a closure element, respectively, or can be connected to branch members having outlet openings that are provided with identical or different cross-sections (diameters).

A further advantage of detachable branch members that are detachable from the base member resides in that the liquid distributor is employed initially with precisely the number of branch members or outlet openings that are actually required. All outlets of the base member that are not needed can be closed initially by closure elements. As soon as additional branch members or outlet openings are required on the liquid distributor, closure elements can be exchanged for branch members at any time. The liquid distributor is thus expandable in a simple way. It is not required to install a completely new liquid distributor.

In an advantageous embodiment of the invention, the branch member is connected to the base member so as to be rotatable about its longitudinal axis, in particular, by 360 degrees. By this positional change of the branch member relative to the base member, the position of the outlet opening relative to the liquid distributor or to the watering system can be changed and adjusted or adapted to the individual conditions or requirements.

### BRIEF DESCRIPTION OF THE DRAWING

Further advantageous details and configurations of the invention result from the dependent claims and the schematically illustrated embodiments of the invention described in the following. Inasmuch as there are several elements that are identified by same numerals, the features and configurations of these individual elements of the distributor for liquids disclosed in the claims and in the description may all be contained or only individual ones may be contained in the distributor.

FIG. 1 shows a liquid distributor according to the invention with three outlets of which two are provided with branch members and one is closed off by a closure element.

FIG. 2 shows the object of FIG. 1 in which however all outlets are connected to branch members.

FIG. 3 shows the object of FIG. 1 and FIG. 2 with detached closure element and detached branch member.

FIG. 4 shows the object of FIG. 2 in partially sectioned illustration.

### DESCRIPTION OF THE PREFERRED EMBODIMENTS

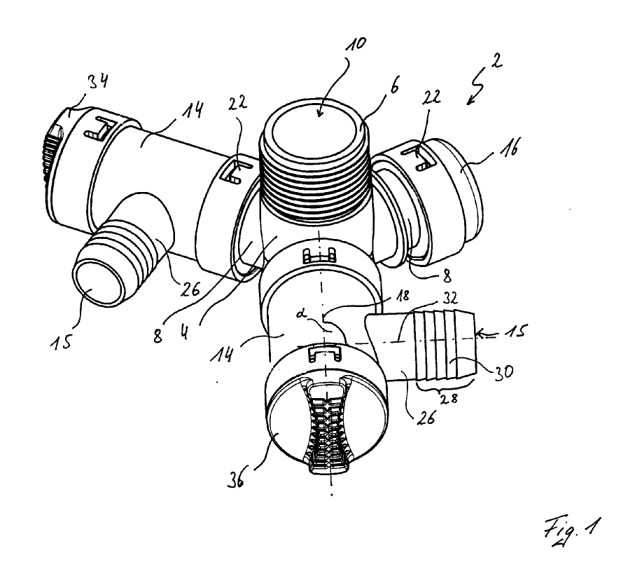

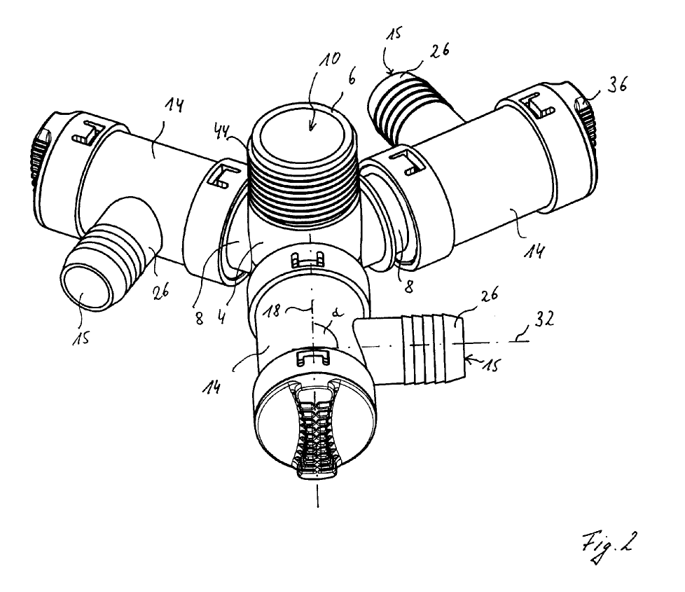

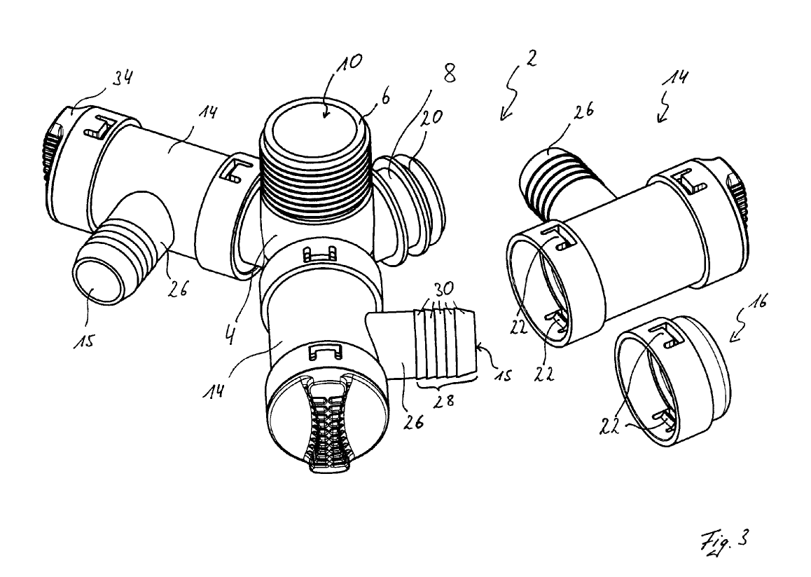

FIGS. 1 through 4 show as a whole a liquid distributor 2 according to the invention in a perspective view. In the following, functionally identical elements of the liquid distributor of which several are present are identified by same numerals. The liquid distributor 2 comprises a base member 4 having an intake 6 and three outlets 8 positioned in a common plane and spaced by an angle of 120 degrees from one another. The intake 6 ends at an inlet opening 10 through which water can flow into the distributor 2 to be distributed to the outlets 8.

Two of the three outlets 8 in FIG. 1 are connected to branch members 14 that each have an outlet opening 15. The third outlet 8 is water-tightly closed by means of a closure element 16. The branch members 14 and also the closure element 16 are removable, i.e., detachably connected, to the outlets 8. Since the outlets 8 are identical, the branch members 14 and the closure element 16 can be exchanged as needed on the outlets 8.

The branch members 14 can be connected to the base member 4 so as to be rotatable about their longitudinal axis 18 by 360 degrees. The connection between the branch members 14 and the base member 4 is realized by a circumferential groove 20 on the outlets 8 and springs 22 on the branch members 14 that are complementary to these grooves 20. In the same way, the closure element 16 also has a complementary spring 22 for securing the closure element 16 on the outlet 8. The connection between the branch members 14 or the closure element 16 and the base member 8 can also be provided by a separate connecting element. However, this configuration is not illustrated in the drawings.

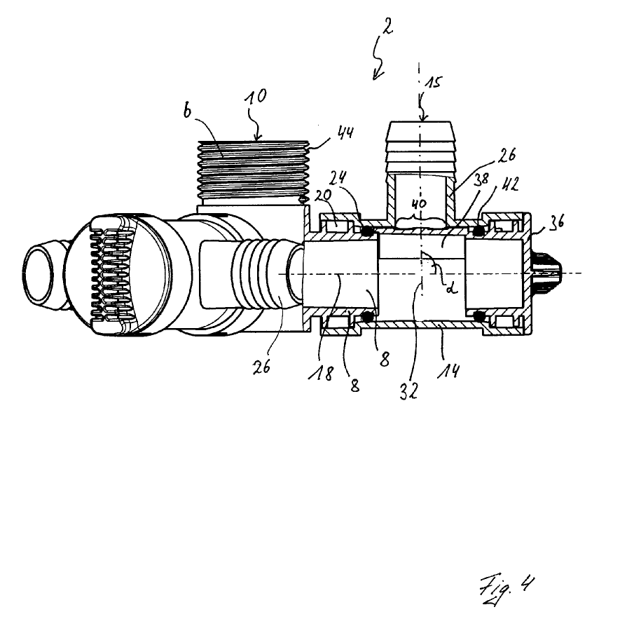

Seals 24, in particular, sealing rings, are arranged between the outlets 8 and the branch members 14 or the closure element 16; the position of the seals is illustrated in FIG. 4 for one of the seals 24.

The branch members 14 each have a discharge socket 26 that ends in an outlet opening 15, respectively. The inlet opening 10 and the outlet openings 15 are connected to another by the hollow interior of the base member 4 for distributing the liquid.

The discharge sockets 26 each have a connecting area 28 for a hose connection and/or pipe connection; the connecting area 28 is comprised of several concavely tapering partial segments 30 that taper in the direction toward the outlet opening 15. In this way, it is prevented that the hose connection can accidentally slip off the discharge sockets 26.

The longitudinal axes 32 of the discharge sockets 26 define an angle α with the longitudinal axis 18 of the branch members 14, respectively. In the illustrated embodiment, the angle α is 90 degrees, respectively. However, the angle α can also be of any other size, for example, 30 degrees, 45 degrees, 60 degrees, 75 degrees, or even 105 degrees, 120 degrees, 135 degrees, 150 degrees, wherein the discharge socket 26 of one branch member 14 can have a different angle than the discharge sockets 26 of the other branch members 14. This configuration is however not shown in the illustrated embodiments. By means of the rotating connection of the branch members 14 and the base member 4 or the outlets 8, the discharge sockets 26 are also rotatable by 360 degrees about the longitudinal axis 18 of the branch members 14, respectively. The adaptability of the liquid distributor 2 is thus significantly increased because the orientation of the hose connections connected to the liquid distributor 2 and extending away from the liquid distributor 2 can be selected freely.

The branch members 14 each have a regulating valve 34. Of course, it is possible that only individual branch members 14 have a regulating valve 34. The regulating valves 34 are provided for controlling the liquid quantity that exits through the outlet openings 15. The regulating valve 34 is illustrated in a section view in FIG. 4. It has a rotary element 36 and a cover element 38 connected thereto and configured to be substantially a half shell. By rotating the rotary element 36, the cover element 38 is pivotable into a position in front of an opening 40 of the branch member 14 that opens into the discharge socket 26. By means of the cover element 38, the opening 40 can be covered completely or only partially. Between the branch member 14 and the regulating valve 34 an annular seal 42 is mounted that prevents undesirable escape of liquid from the branch member 14 in the area of the rotary element 36.

The intake 6 of the base member 4 has a connecting thread 44. In this way, a fixed connection to a liquid supply line is enabled.

While specific embodiments of the invention have been shown and described in detail to illustrate the inventive principles, it will be understood that the invention may be embodied otherwise without departing from such principles.

What is claimed is:

1. A distributor for liquids, the distributor comprising:
a base member having an intake and at least two outlets;
at least one branch member connected to one of the at least two outlets in a position that is changeable relative to the base member;
wherein the at least one branch member has an outlet opening.

2. The distributor according to claim 1, wherein the at least one branch member is detachably connected to the base member.

3. The distributor according to claim 2, further comprising a closure element connectable to said one of the at least two outlets for closing off said one outlet when the at least one branch member has been detached.

4. The distributor according to claim 1, wherein the at least one branch member has a longitudinal axis and is rotatable relative to the base member about the longitudinal axis.

5. The distributor according to claim 4, wherein the at least one branch member is rotatable about 360 degrees about the longitudinal axis.

6. The distributor according to claim 1, wherein the at least two outlets each have a circumferential groove and wherein the at least one branch member has a spring that is complementary to the circumferential groove, wherein the circumferential groove and the spring engage one another for connecting the at least one branch member to the at least two outlets, respectively.

7. The distributor according to claim 1, wherein the at least one branch member has a discharge socket.

8. The distributor according to claim 7, wherein the discharge socket has a longitudinal axis positioned angularly relative to a longitudinal axis of the at least one branch member.

9. The distributor according to claim 1, wherein the at least one branch member comprises a regulating valve for controlling a quantity of liquid exiting through the outlet opening.

10. The distributor according to claim 9, wherein the regulating valve has a rotary element and a cover element connected to the rotary element and wherein the cover element is pivotable into a position in front of an opening of the at least one branch member.

11. The distributor according to claim 1, wherein the intake of the base member ends in an inlet opening.

12. The distributor according to claim 1, wherein the intake has a connecting thread.

13. The distributor according to claim 1, wherein the base member has three of the at least two outlets and wherein the three outlets are arranged in a common plane and are spaced relative to one another at an angle of 120 degrees.

14. A distributor kit comprising:
a distributor according to claim 1;
a closure element for closing one of the at least two outlets of the base member of the distributor; and
branch elements for each one the at least two outlets that is not closed off by the closure element.
